(19) United States
(12) Patent Application Publication
(10) Pub. No.: US 2024/0369687 A1
(43) Pub. Date: Nov. 7, 2024

(54) OPTICAL SENSING MODULE AND HANDHELD DEVICE CASING INCLUDING THE OPTICAL SENSING MODULE

(71) Applicant: Cheng Uei Precision Industry Co., Ltd., New Taipei City (TW)

(72) Inventor: Chin Chung Lin, New Taipei City (TW)

(21) Appl. No.: 18/415,651

(22) Filed: Jan. 18, 2024

(30) Foreign Application Priority Data
May 3, 2023 (CN) 202321026399.1

(51) Int. Cl. G01S 7/481

(52) U.S. Cl. CPC G01S 7/4816; G01S 7/4811; G01S 7/4814

(57) ABSTRACT

A handheld device casing includes a rear cover, an optical sensing module, a frame and a shell. The optical sensing module is disposed in the rear cover. The optical sensing module includes a bracket, a circuit board, a light emitting diode, an infrared sensor and a first shading structure. The bracket has an isolating wall. An inside of the bracket is separated into a first opening and a second opening by the isolating wall. The circuit board is disposed in the bracket. The light emitting diode is disposed to a front surface of the circuit board. The infrared sensor is located in the second opening. The first shading structure is disposed to an upper portion and an outer side of the first opening. The frame is disposed to a front surface of the rear cover. The shell is disposed to a front surface of the frame.

### CROSS-REFERENCE TO RELATED APPLICATION

The present application is based on, and claims priority from, China Patent Application No. 202321026399.1, filed May 3, 2023, the disclosure of which is hereby incorporated by reference herein in its entirety.

### BACKGROUND OF THE INVENTION

### 1. Field of the Invention

The present invention generally relates to an optical sensing module, and more particularly to an optical sensing module which is able to complete prevent a light interference and improve a detection accuracy, and a handheld device casing including the optical sensing module.

### 2. Description of the Prior Art

An optical sensing module includes a light emitting portion for transmitting a light beam, and a light receiving portion for receiving the light beam. When a projected light is blocked or is reflected by a detected object, a light receiving quantity which is reached to the light receiving portion is changed. As long as the light receiving portion detects a light variation, the light receiving portion will convert the light variation into an electronic signal, and then the light receiving portion outputs the electronic signal. Generally, the light beam of the light emitting portion mostly uses a visible light and an infrared light.

A conventional distance sensor includes a base board, a light-emitting chip, a sensing chip, a separation glue wall and a light blocking shell. The light-emitting chip and the sensing chip are mounted to the base board. The separation glue wall is disposed to sensing chip, and the separation glue wall protrudes beyond the sensing chip. The light blocking shell is mounted to the base board. An inner cavity of the light blocking shell is separated into a first cavity and a second cavity by the separation glue wall. According to the conventional distance sensor and a manufacturing method of the conventional distance sensor, the separation glue wall is disposed between a photosensitive area of a transmitting end and a photosensitive area of a receiving end. The separation glue wall is able to completely isolate the first cavity and the second cavity to prevent a light interference between the first cavity and the second cavity.

However, though the inner cavity of the above-mentioned light blocking shell of the above-mentioned conventional distance sensor is separated into the first cavity and the second cavity by the separation glue wall, leaking light still exists to affect a detection accuracy of the above-mentioned conventional distance sensor.

Thus, it is essential to provide an innovative optical sensing module, and a handheld device casing including the optical sensing module. The innovative optical sensing module is able to completely prevent a light interference and improve a detection accuracy.

### SUMMARY OF THE INVENTION

An object of the present invention is to provide an optical sensing module which is able to completely prevent a light interference and improve a detection accuracy, and a handheld device casing including the optical sensing module. The optical sensing module includes a bracket, a circuit board, a light emitting diode, an infrared sensor and a connector. The bracket is hollow. The bracket has an isolating wall. The isolating wall is disposed in an inside of the bracket. The isolating wall is connected with two opposite sides of the bracket. The inside of the bracket is separated into a first opening and a second opening by the isolating wall. Several portions of two inner surfaces of two opposite sides of the first opening and an inner surface of one side of the second opening extend inward to form a plurality of blocking walls. A rear of one side of the bracket extends rearward and then is bent inward to form a first locking hook. The first locking hook is disposed in the second opening. The circuit board is disposed in the bracket. The circuit board is located among the first locking hook and the plurality of the blocking walls. The light emitting diode is disposed to a front surface of the circuit board. The light emitting diode is located in the first opening. The infrared sensor is disposed to the front surface of the circuit board. The infrared sensor is located in the second opening. The isolating wall is located between the light emitting diode and the infrared sensor. The connector is disposed to a rear surface of the circuit board.

Another object of the present invention is to provide a handheld device casing. The handheld device casing includes a rear cover, an optical sensing module, a frame and a shell. The rear cover has a first extending portion and a second extending portion. A lower portion of a front surface of the rear cover extends frontward to form the first extending portion. The lower portion of the front surface of the rear cover extends frontward to form the second extending portion. The optical sensing module is disposed in the rear cover. An upper end and a lower end of the optical sensing module are corresponding to a front of the first extending portion and a front of the second extending portion. The optical sensing module includes a bracket, a circuit board, a light emitting diode, an infrared sensor and a first shading structure. An upper portion of the bracket is mounted to the front of the first extending portion. A lower portion of the bracket is mounted to the front of the second extending portion of the rear cover. The bracket has an isolating wall. The bracket is hollow. The isolating wall is disposed in a middle of an inside of the bracket. The isolating wall is connected with two opposite sides of the bracket. The inside of the bracket is separated into a first opening and a second opening by the isolating wall. The circuit board is disposed in the bracket. An upper portion of the circuit board is corresponding to the front of the first extending portion. The upper portion of the circuit board is mounted to the front of the first extending portion. The light emitting diode is disposed to a front surface of the circuit board. The light emitting diode is located in the first opening. The infrared sensor is disposed to the front surface of the circuit board. The infrared sensor is located in the second opening. The isolating wall is located between the light emitting diode and the infrared sensor. The first shading structure is disposed to an upper portion and an outer side of the first opening. The first shading structure shields the upper portion and the outer side of the first opening. The frame is disposed to the front surface of the rear cover. The shell is disposed to a front surface of the frame. The shell has a lens, a light guiding column and a second shading structure. The lens is corresponding to the infrared sensor. The light guiding column is corresponding to the light emitting diode. The light guiding column is located between the first shading structure and the second shading structure. The second shading structure is disposed to a lower portion and the outer side of the first opening. The second shading structure is adjacent to an inside of the first shading structure. The second shading structure shields the lower portion and the outer side of the first opening.

Another object of the present invention is to provide a handheld device casing. The handheld device casing includes a rear cover, an optical sensing module, a frame and a shell. A lower portion of a front surface of the rear cover extends frontward to form a first extending portion. The lower portion of the front surface of the rear cover extends frontward to form a second extending portion. The lower portion of the front surface of the rear cover extends frontward to form an abutting portion. The abutting portion is disposed between the first extending portion and the second extending portion. A length of the first extending portion is longer than a length of the second extending portion, and the length of the second extending portion is longer than a length of the abutting portion. The optical sensing module is disposed in the rear cover. An upper end and a lower end of the optical sensing module are corresponding to a front of the first extending portion and a front of the second extending portion. The optical sensing module includes a bracket, a circuit board, a light emitting diode, an infrared sensor and a first shading structure. An upper portion of the bracket is mounted to the front of the first extending portion. A lower portion of the bracket is mounted to the front of the second extending portion of the rear cover. The bracket has an isolating wall. The bracket is hollow. The isolating wall is disposed in an inside of the bracket. The inside of the bracket is separated into a first opening and a second opening by the isolating wall. The circuit board is disposed in the bracket. An upper portion of the circuit board is mounted to the front of the first extending portion. A lower portion of the circuit board abuts against the abutting portion of the rear cover. The light emitting diode is disposed to a front surface of the circuit board. The light emitting diode is located in the first opening. The infrared sensor is disposed to the front surface of the circuit board. The infrared sensor is located in the second opening. The isolating wall is located between the light emitting diode and the infrared sensor. The first shading structure is disposed to an upper portion and an outer side of the first opening. The first shading structure shields the upper portion and the outer side of the first opening. The frame is disposed to the front surface of the rear cover. The shell is disposed to a front surface of the frame. The shell has a lens, a light guiding column and a second shading structure. The lens is corresponding to the infrared sensor. The light guiding column is corresponding to the light emitting diode. The light guiding column is located between the first shading structure and the second shading structure. The second shading structure is disposed to a lower portion and the outer side of the first opening. The second shading structure is adjacent to an inside of the first shading structure. The second shading structure shields the lower portion and the outer side of the first opening.

As described above, the isolating wall of the optical sensing module is able to completely isolate the first opening from the second opening to prevent a light interference caused between the first opening and the second opening. The first shading structure shields the upper portion and a left side of the first opening to prevent a light leakage of the light emitting diode, and the second shading structure shields the lower portion and the left side of the first opening, so that the second shading structure prevents a light beam leaking from a junction between the optical sensing module and the shell. A right side of the first opening is adjacent to a center of an inside of the rear cover to prevent the light leakage, so that a lower detection accuracy technology problem caused by the light leakage of a current optical sensing module is solved, and the detection accuracy of the optical sensing module is improved. Furthermore, the length of the first extending portion is longer than the length of second extending portion, and the length of second extending portion is longer than the length of the abutting portion, so the optical sensing module is slantwise mounted in the rear cover. As a result, a sensitivity of the optical sensing module is improved.

### BRIEF DESCRIPTION OF THE DRAWINGS

The present invention will be apparent to those skilled in the art by reading the following description, with reference to the attached drawings, in which:

FIG. 1 is a perspective view of a handheld device casing including an optical sensing module in accordance with a preferred embodiment of the present invention;

FIG. 2 is a diagrammatic drawing of the handheld device casing including the optical sensing module of FIG. 1;

FIG. 3 is a sectional view of the handheld device casing including the optical sensing module along a line III-III of FIG. 2;

FIG. 4 is a partially exploded view of the handheld device casing including the optical sensing module of FIG. 1;

FIG. 5 is another partially exploded view of the handheld device casing including the optical sensing module of FIG. 1;

FIG. 6 is a perspective view of a rear cover of the handheld device casing including the optical sensing module of FIG. 1;

FIG. 7 is an enlarged view of an encircled portion VII of the rear cover of the handheld device casing including the optical sensing module of FIG. 6;

FIG. 8 is a perspective view of the optical sensing module of FIG. 1;

FIG. 9 is another perspective view of the optical sensing module of FIG. 8;

FIG. 10 is an exploded view of the optical sensing module of FIG. 8;

FIG. 11 is a perspective view of a shell of the handheld device casing including the optical sensing module of FIG. 1; and

FIG. 12 is an enlarged view of an encircled portion XII of the shell of the handheld device casing including the optical sensing module of FIG. 11.

### DETAILED DESCRIPTION OF THE INVENTION

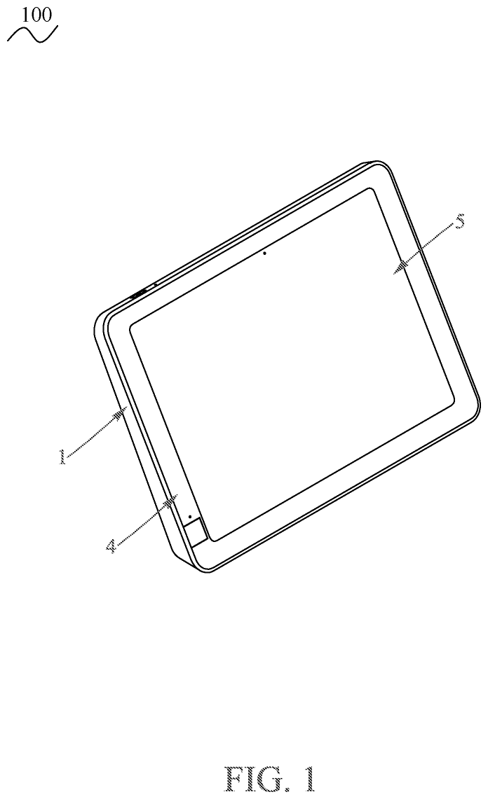

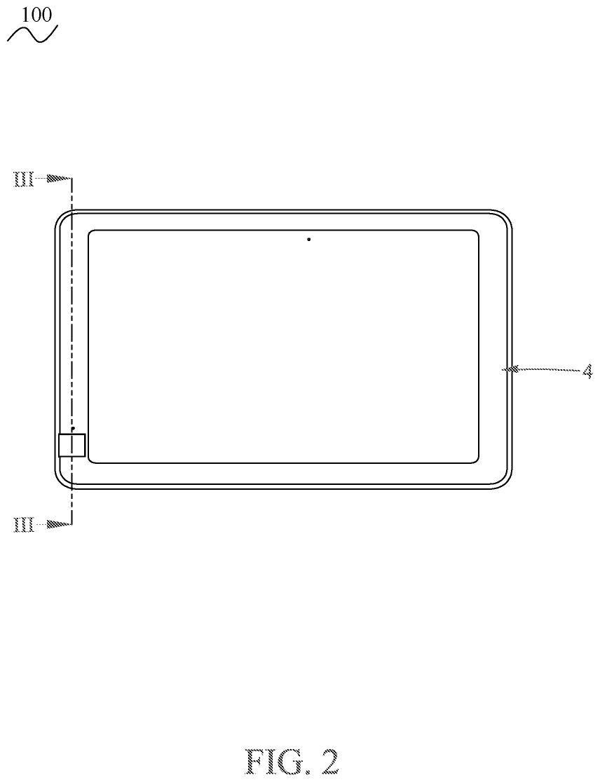

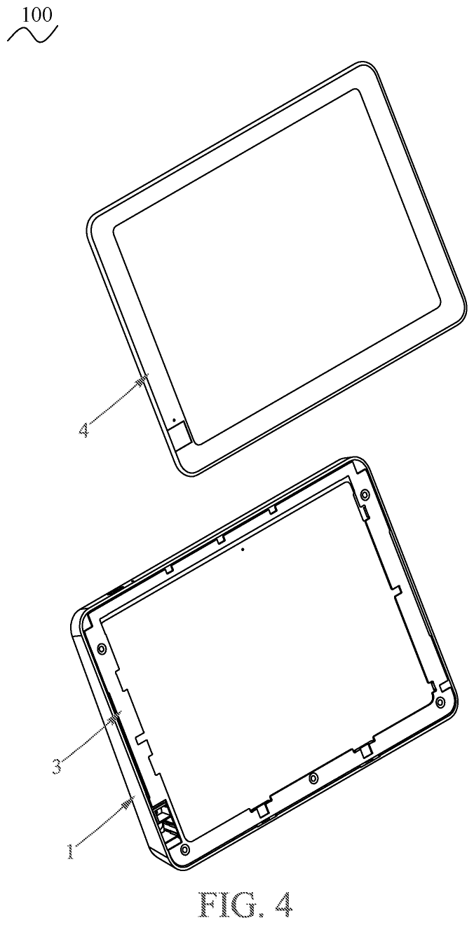

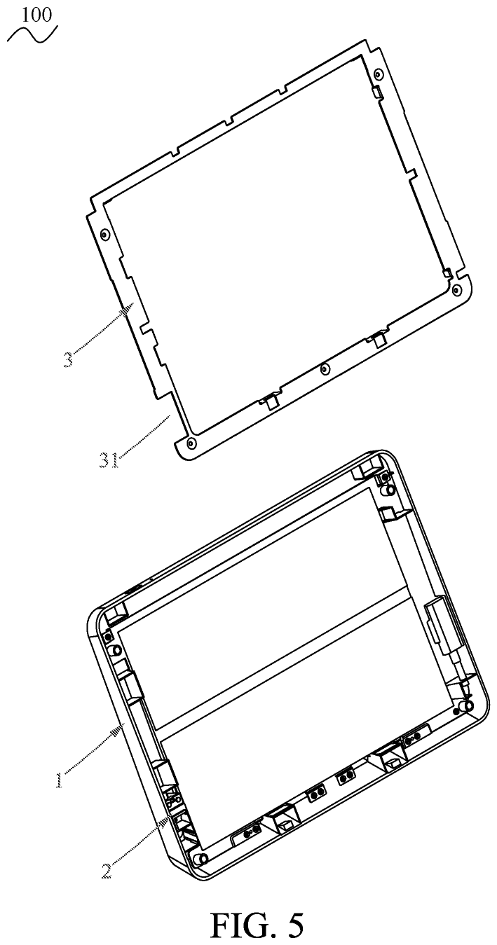

With reference to FIG. 1 to FIG. 5, an optical sensing module 2, and a handheld device casing 100 including the optical sensing module 2 in accordance with a preferred embodiment of the present invention are shown. The handheld device casing 100 includes a rear cover 1, the optical sensing module 2, a frame 3, a shell 4 and a handheld computer 5. The optical sensing module 2 is disposed in the rear cover 1. The frame 3 is disposed to a front surface of the rear cover 1. The shell 4 is disposed to a front surface of the frame 3. The handheld computer 5 is disposed to a middle of the rear cover 1. The handheld computer 5 is a tablet computer. In the preferred embodiment, the handheld computer 5 is an iPad.

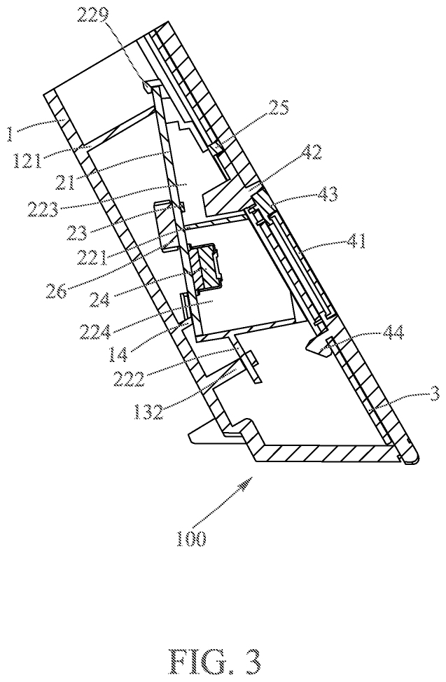

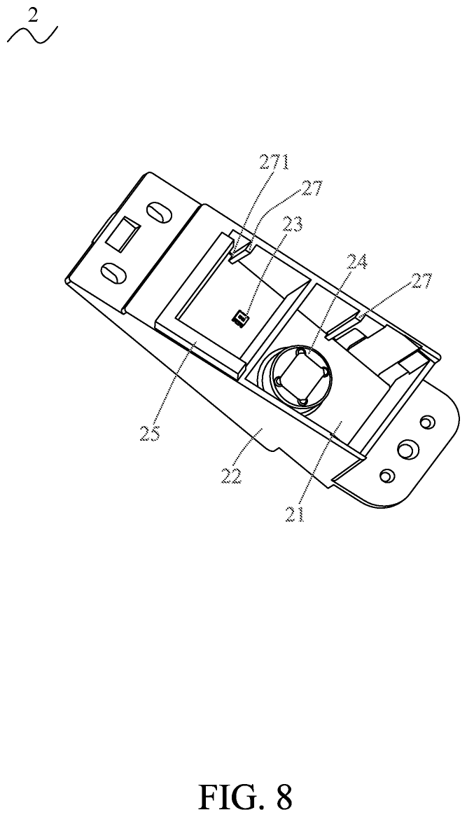

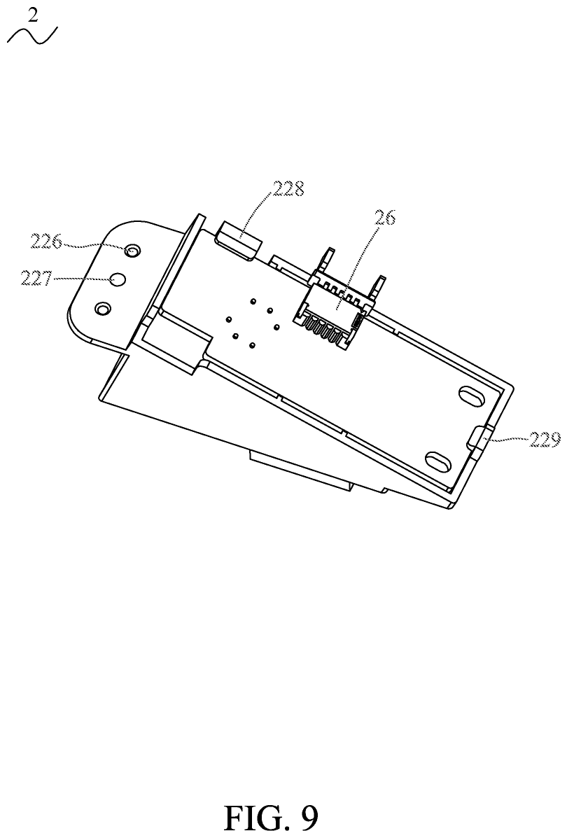

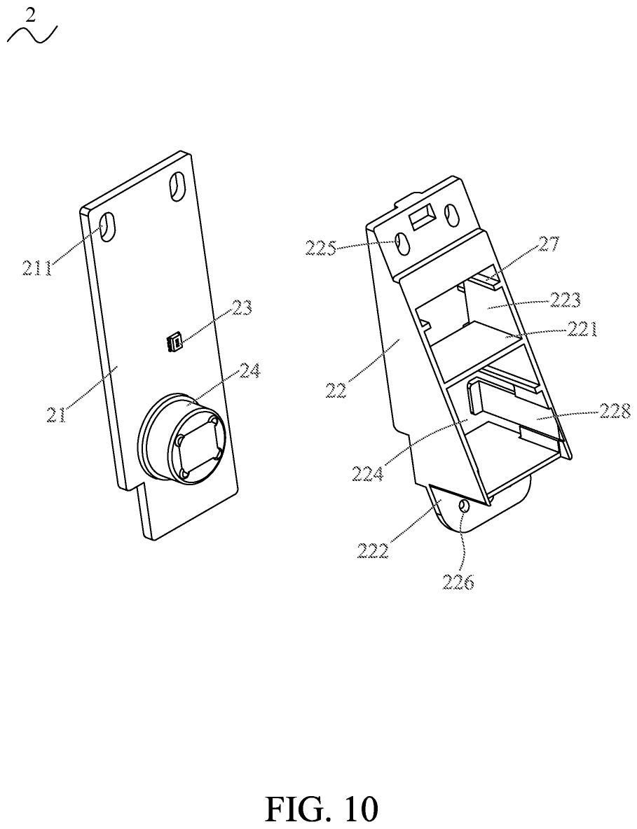

Referring to FIG. 3 to FIG. 10, the optical sensing module 2 includes a circuit board 21, a bracket 22, a light emitting diode 23, an infrared sensor 24, a first shading structure 25, a connector 26 and a plurality of blocking walls 27. The circuit board 21 is disposed in the bracket 22. An upper portion of the circuit board 21 is corresponding to a corresponding mechanism of the rear cover 1. A lower portion of the circuit board 21 is corresponding to the corresponding mechanism of the rear cover 1. A lower portion of the bracket 22 is corresponding to the corresponding mechanism of the rear cover 1.

The light emitting diode 23 is disposed to a front surface of the circuit board 21. The infrared sensor 24 is disposed to the front surface of the circuit board 21. The first shading structure 25 is disposed to a front surface of the bracket 22. The first shading structure 25 prevents a light leakage from a junction between the optical sensing module 2 and the shell 4. In the preferred embodiment, the first shading structure 25 is an L shape sponge. In a concrete implementation, the first shading structure 25 is without being limited to be the L shape sponge.

The bracket 22 has an isolating wall 221, a fastening portion 222, a first opening 223, a second opening 224, at least one second location hole 225, two third location holes 226, a fourth location hole 227, a first locking hook 228 and a second locking hook 229. In the preferred embodiment, the bracket 22 has two abreast second location holes 225. The bracket 22 is hollow. The bracket 22 is a hollow rectangular body seen from a front view. An upper portion and a lower portion of the bracket 22 defines the first opening 223 and the second opening 224, respectively. The first opening 223 and the second opening 224 penetrate through the bracket 22 along a front-to-rear direction. The isolating wall 221 is disposed in a middle of an inside of the bracket 22. The isolating wall 221 is connected with two opposite sides of the bracket 22. The inside of the bracket 22 of the optical sensing module 2 is separated into the first opening 223 and the second opening 224 by the isolating wall 221. The first opening 223 and the second opening 224 are isolated by the isolating wall 221. The isolating wall 221 is able to completely isolate the first opening 223 from the second opening 224 to prevent a light interference caused between the first opening 223 and the second opening 224.

The connector 26 is disposed to a rear surface of the circuit board 21. Several portions of two inner surfaces of the two opposite sides of the bracket 22 extend inward to form the plurality of the blocking walls 27. The plurality of the blocking walls 27 are used for locating the circuit board 21, and the plurality of the blocking walls 27 are used for fastening the circuit board 21. Inner surfaces of the plurality of the blocking walls 27 are recessed outward to form a plurality of buckling grooves 271 penetrating through bottom surfaces of the plurality of the blocking walls 27.

In the preferred embodiment, the first opening 223 is disposed above the second opening 224. The isolating wall 221 is located between the light emitting diode 23 and the infrared sensor 24. The light emitting diode 23 is located in the first opening 223. The infrared sensor 24 is located in the second opening 224. The first shading structure 25 is disposed to an upper portion and one side of the first opening 223. The first shading structure 25 shields the upper portion and the one side of the first opening 223. Specifically, the first shading structure 25 is disposed to the upper portion and a left side of the first opening 223. The first shading structure 25 shields the upper portion and the left side of the first opening 223 to prevent the light leakage of the light emitting diode 23. The first shading structure 25 is disposed to the upper portion and an outer side of the first opening 223. The first shading structure 25 shields the upper portion and the outer side of the first opening 223.

The isolating wall 221 and the first shading structure 25 prevent causing the light leakage of the light emitting diode 23 to affect the infrared sensor 24. The isolating wall 221 and the first shading structure 25 prevent the infrared sensor 24 from a false triggering, and a right side of the first opening 223 is adjacent to a center of an inside of the rear cover 1 to prevent the light leakage, so that a lower detection accuracy technology problem caused by a light leakage of a current optical sensing module is solved, and a detection accuracy of the optical sensing module 2 is improved. In the preferred embodiment, several portions of two two inner surfaces of two opposite sides of the first opening 223 and an inner surface of one side of the second opening 224 extend inward to form the plurality of the blocking walls 27.

The circuit board 21 has at least one first location hole 211 penetrating through a front surface and a rear surface of the upper portion of the circuit board 21. The at least one first location hole 211 is corresponding to a corresponding zone of the rear cover 1. The at least one first location hole 211 is corresponding to a corresponding part of the bracket 22. In the preferred embodiment, the circuit board 21 has two abreast first location holes 211 penetrating through the front surface and the rear surface of the upper portion of the circuit board 21. The two first location holes 211 are corresponding to the two corresponding zones of the rear cover 1, respectively. The two first location holes 211 are corresponding to two corresponding parts of the bracket 22, respectively.

An upper portion of the bracket 22 has the at least one second location hole 225 penetrating through the front surface and a rear surface of the bracket 22. The at least one first location hole 211 is corresponding to the at least one second location hole 225. The two second location holes 225 penetrate through a front surface and a rear surface of the upper portion of the bracket 22. The two second location holes 225 are transversely arranged. The two first location holes 211 are corresponding to the two second location holes 225. A quantity of the at least one second location hole 225 is corresponding to a quantity of the at least one first location hole 211 of the circuit board 21. The two first location holes 211 of the circuit board 21 and the two second location holes 225 of the bracket 22 are corresponding to two corresponding zones of the rear cover 1, and then screwing elements are fastened in the two first location holes 211, the two second location holes 225 and the two corresponding zones of the rear cover 1 to realize that the circuit board 21 and the bracket 22 are located to the rear cover 1, and the circuit board 21 and the bracket 22 are fixed to the rear cover 1. The two corresponding parts of the bracket 22 are the two second location holes 225 of the bracket 22.

A lower surface of the bracket 22 slantwise extends downward and frontward to form the fastening portion 222. The fastening portion 222 is corresponding to a corresponding area of the rear cover 1. Two sides of the fastening portion 222 defines the two third location holes 226 penetrating through a front surface and a rear surface of the fastening portion 222, respectively. A middle of the fastening portion 222 defines the fourth location hole 227 penetrating through the front surface and the rear surface of the fastening portion 222. The fourth location hole 227 is disposed between the two third location holes 226. The two third location holes 226 are corresponding to two corresponding segments of the rear cover 1. The two corresponding segments of the rear cover 1 penetrate through the two third location holes 226 to realize that the optical sensing module 2 is located to the rear cover 1, and the optical sensing module 2 is fixed to the rear cover 1. The fourth location hole 227 is corresponding to a corresponding construction of the rear cover 1, and then a screwing component is fastened in the corresponding construction of the rear cover 1 to realize that the optical sensing module 2 is located to the rear cover 1, and the optical sensing module 2 is fixed to the rear cover 1.

A rear of one side of the bracket 22 extends rearward and then is bent inward to form the first locking hook 228. The circuit board 21 is disposed at the first locking hook 228. The first locking hook 228 is used for fastening the circuit board 21. The circuit board 21 is mounted at a front of the first locking hook 228. The circuit board 21 is located among the first locking hook 228 and the plurality of the blocking walls 27. Two substantial middles of two sides of the circuit board 21 are buckled in the plurality of the buckling grooves 271. A lower portion of one side of the circuit board 21 is hooked by the first locking hook 228. In the preferred embodiment, the first locking hook 228 is disposed in the second opening 224. The first locking hook 228 and the blocking wall 27 in the second opening 224 are disposed at the same side of the bracket 22. A middle of the rear surface of the upper portion of the bracket 22 extends rearward and then is bent inward to form the second locking hook 229. The second locking hook 229 is used for fastening the circuit board 21. An upper end of the circuit board 21 is hooked by the second locking hook 229. The circuit board 21 is mounted at a front of the second locking hook 229. The circuit board 21 is fastened to the rear surface of the bracket 22 by the first locking hook 228 and the second locking hook 229. The first locking hook 228 and the second locking hook 229 prevent the circuit board 21 falling off from the rear surface of the bracket 22.

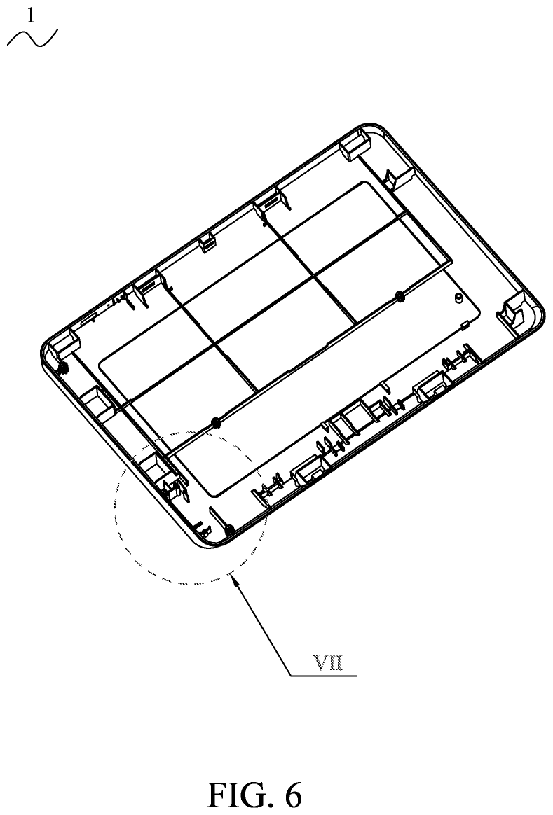

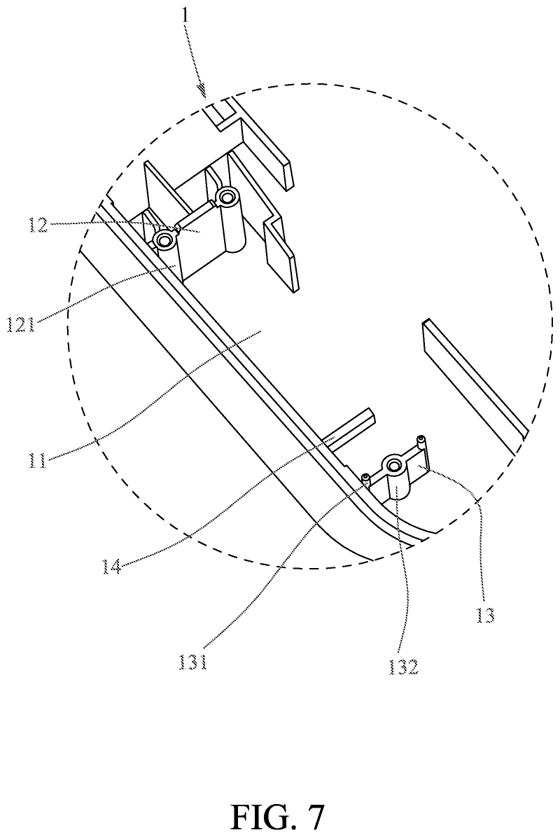

Referring to FIG. 6 and FIG. 7, the rear cover 1 is a rectangular shape. A front of the rear cover 1 is opened freely. The rear cover 1 has a mounting portion 11, a first extending portion 12, a second extending portion 13 and an abutting portion 14. A lower portion of one side of rear cover 1 has the mounting portion 11. The optical sensing module 2 is disposed in the mounting portion 11. A lower portion of the front surface of the rear cover 1 extends frontward to form the first extending portion 12. The lower portion of the front surface of the rear cover 1 extends frontward to form the second extending portion 13. The lower portion of the front surface of the rear cover 1 extends frontward to form the abutting portion 14. The first extending portion 12 is disposed to an upper portion of the mounting portion 11. The second extending portion 13 is disposed to a lower portion of the mounting portion 11. The abutting portion 14 is disposed in the mounting portion 11. The abutting portion 14 is disposed between the first extending portion 12 and the second extending portion 13. The abutting portion 14 is disposed adjacent to the second extending portion 13.

The upper portion of the circuit board 21 of the optical sensing module 2 is corresponding to a front of the first extending portion 12 of the rear cover 1. The upper portion of the circuit board 21 of the optical sensing module 2 is mounted to the front of the first extending portion 12 of the rear cover 1. An upper end and a lower end of the optical sensing module 2 are corresponding to the front of the first extending portion 12 and a front of the second extending portion 13. The lower portion of the circuit board 21 of the optical sensing module 2 is corresponding to the abutting portion 14 of the rear cover 1. The lower portion of the circuit board 21 of the optical sensing module 2 is mounted to the abutting portion 14 of the rear cover 1. The lower portion of the circuit board 21 of the optical sensing module 2 abuts against the abutting portion 14 of the rear cover 1. The upper portion of the bracket 22 is mounted to the front of the first extending portion 12. The lower portion of the bracket 22 is corresponding to the front of the second extending portion 13 of the rear cover 1. The lower portion of the bracket 22 is mounted to the front of the second extending portion 13 of the rear cover 1. In the preferred embodiment, a length of the first extending portion 12 of the mounting portion 11 is longer than a length of the second extending portion 13 of the mounting portion 11, and the length of the second extending portion 13 of the mounting portion 11 is longer than a length of the abutting portion 14 of the mounting portion 11, so the optical sensing module 2 is slantwise mounted in the rear cover 1. A sensitivity of the optical sensing module 2 is improved. The second extending portion 13 is positioned below the first extending portion 12. The corresponding mechanism of the rear cover 1 includes the first extending portion 12, the abutting portion 14 and the second extending portion 13 of the rear cover 1.

The first extending portion 12 has at least one first locating pillar 121 penetrating through the front of the first extending portion 12. The at least one first location hole 211 and the at least one second location hole 225 are corresponding to the at least one first locating pillar 121. In the preferred embodiment, the first extending portion 12 has two first locating pillars 121 penetrating through the front of the first extending portion 12. The two first locating pillars 121 are disposed to two opposite sides of the first extending portion 12, respectively. The two first locating pillars 121 are corresponding to the two first location holes 211 of the circuit board 21 of the optical sensing module 2 and the two second location holes 225 of the bracket 22 of the optical sensing module 2, and the two screwing elements are fastened in the two first location holes 211, the two second location holes 225 and the two first locating pillars 121 to realize that the optical sensing module 2 is located to the rear cover 1, and the optical sensing module 2 is fixed to the rear cover 1. The two corresponding zones of the rear cover 1 are the two first locating pillars 121 of the first extending portion 12.

The second extending portion 13 has two fastening pillars 131 and a second locating pillar 132. Two opposite sides of the second extending portion 13 extend frontward to form the two fastening pillars 131. Two middles of the two fastening pillars 131 penetrate through the front of the second extending portion 13. The two fastening pillars 131 are corresponding to the two third location holes 226 of the bracket 22 of the optical sensing module 2, respectively. The second locating pillar 132 is disposed at a middle of the second extending portion 13. The second locating pillar 132 is disposed between the two fastening pillars 131. The second locating pillar 132 penetrates through the front of the second extending portion 13. The second locating pillar 132 is corresponding to the fourth location hole 227 of the bracket 22 of the optical sensing module 2, and then the screwing component is fastened in the fourth location hole 227 and the second locating pillar 132 to realize that the optical sensing module 2 is located to the rear cover 1, and the optical sensing module 2 is fixed to the rear cover 1. The corresponding area of the rear cover 1 is the second extending portion 13. The two corresponding segments of the rear cover 1 are the two fastening pillars 131 of the second extending portion 13. The corresponding construction of the rear cover 1 is the second locating pillar 132 of the second extending portion 13.

Referring to FIG. 3 to FIG. 5, the frame 3 is disposed to the front surface of the rear cover 1. A lower portion of one side edge of the frame 3 is recessed inward to form a notch 31. The notch 31 is corresponding to the first opening 223, the second opening 224, the first shading structure 25 and a corresponding position of the shell 4.

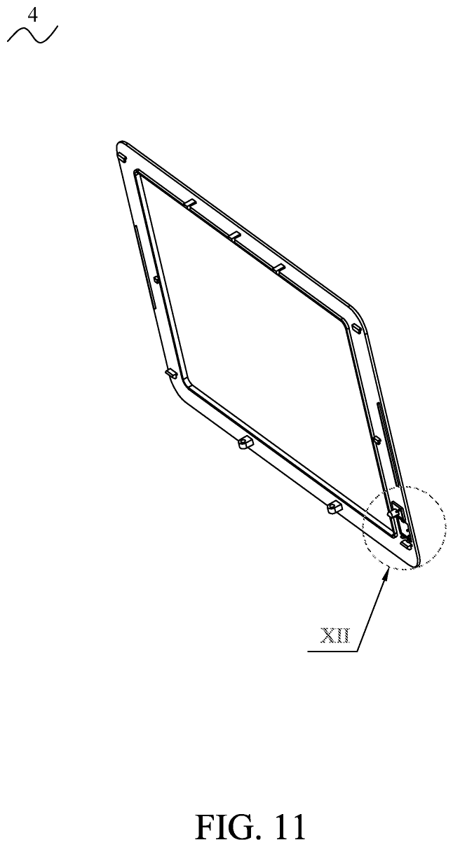

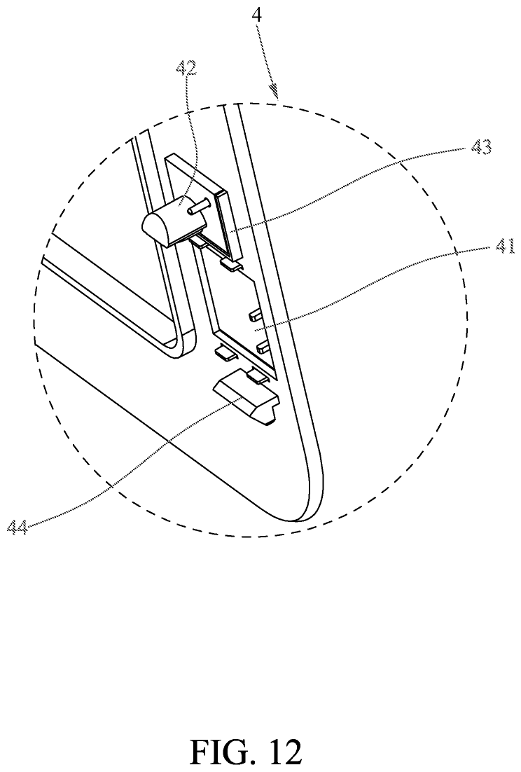

Referring to FIG. 1 to FIG. 12, the shell 4 has a lens 41, a light guiding column 42, a second shading structure 43 and a third locking hook 44. The lens 41, the light guiding column 42, the second shading structure 43 and the third locking hook 44 are corresponding to the notch 31. A rear surface of the shell 4 has the second shading structure 43. The lens 41 is disposed under the light guiding column 42 and the second shading structure 43. The lens 41 is corresponding to the infrared sensor 24 of the optical sensing module 2. The light guiding column 42 is corresponding to the light emitting diode 23 of the optical sensing module 2. The corresponding position of the shell 4 includes the lens 41, the light guiding column 42, the second shading structure 43 and the third locking hook 44.

In the preferred embodiment, the lens 41 is fastened to a front surface of the shell 4 by a hot melting way. The light guiding column 42 is fastened to the rear surface of the shell 4 by the hot melting way. In the concrete implementation, the lens 41 is without being limited to be fastened to the front surface of the shell 4 by the hot melting way, and the light guiding column 42 is without being limited to be fastened to the rear surface of the shell 4 by the hot melting way. The light emitting diode 23 of the optical sensing module 2 emits a light beam, and then the light beam is guided to an outside of the handheld device casing 100 by the light guiding column 42. When the light beam encounters a person, the light beam is refracted, then the refracted light beam penetrates through the lens 41, and the refracted light beam is emitted to the infrared sensor 24 of the optical sensing module 2.

When the light emitting diode 23 of the optical sensing module 2 emits the light beam, the isolating wall 221 of the bracket 22 blocks the light beam from interfering with the infrared sensor 24, so that the false triggering of the infrared sensor 24 is prevented. In the preferred embodiment, the second shading structure 43 is an L shape structure. In the concrete implementation, the second shading structure 43 is without being limited to be the L shape structure. The light guiding column 42 is located between the first shading structure 25 of the optical sensing module 2 and the second shading structure 43 of the shell 4.

The second shading structure 43 is disposed to a lower portion and the one side of the first opening 223. The second shading structure 43 is disposed to the lower portion and the outer side of the first opening 223. The second shading structure 43 is adjacent to an inside of the first shading structure 25. The second shading structure 43 shields the lower portion and the one side of the first opening 223. The second shading structure 43 shields the lower portion and the outer side of the first opening 223. Specifically, the second shading structure 43 is disposed to the lower portion and the left side of the first opening 223. In the preferred embodiment, the second shading structure 43 shields the lower portion and the left side of the first opening 223, so that the second shading structure 43 prevents the light beam leaking from the junction between the optical sensing module 2 and the shell 4. The rear surface of the shell 4 extends rearward to form the third locking hook 44. The third locking hook 44 is disposed under the lens 41. The third locking hook 44 is buckled with the notch 31 of the frame 3 to realize that the shell 4 is located to the frame 3, and the shell 4 is fixed to the frame 3.

As described above, the isolating wall 221 of the optical sensing module 2 is able to completely isolate the first opening 223 from the second opening 224 to prevent the light interference caused between the first opening 223 and the second opening 224. The first shading structure 25 shields the upper portion and the left side of the first opening 223 to prevent the light leakage of the light emitting diode 23, and the second shading structure 43 shields the lower portion and the left side of the first opening 223, so that the second shading structure 43 prevents the light beam leaking from the junction between the optical sensing module 2 and the shell 4. The right side of the first opening 223 is adjacent to the center of the inside of the rear cover 1 and is shielded by the handheld computer 5 to prevent the light leakage, so that the lower detection accuracy technology problem caused by the light leakage of the current optical sensing module is solved, and the detection accuracy of the optical sensing module 2 is improved. Furthermore, the length of the first extending portion 12 of the mounting portion 11 is longer than the length of second extending portion 13 of the mounting portion 11, and the length of second extending portion 13 of the mounting portion 11 is longer than the length of the abutting portion 14 of the mounting portion 11, so the optical sensing module 2 is slantwise mounted in the rear cover 1. As a result, the sensitivity of the optical sensing module 2 is improved.

What is claimed is:

1. An optical sensing module, comprising:
a bracket being hollow, the bracket having an isolating wall, the isolating wall being disposed in an inside of the bracket, the isolating wall being connected with two opposite sides of the bracket, the inside of the bracket being separated into a first opening and a second opening by the isolating wall, several portions of two inner surfaces of two opposite sides of the first opening and an inner surface of one side of the second opening extending inward to form a plurality of blocking walls, a rear of one side of the bracket extending rearward and then being bent inward to form a first locking hook, the first locking hook being disposed in the second opening;
a circuit board disposed in the bracket, the circuit board being located among the first locking hook and the plurality of the blocking walls;
a light emitting diode disposed to a front surface of the circuit board, the light emitting diode being located in the first opening;
an infrared sensor disposed to the front surface of the circuit board, the infrared sensor being located in the second opening, the isolating wall being located between the light emitting diode and the infrared sensor; and
a connector disposed to a rear surface of the circuit board.

2. The optical sensing module as claimed in claim 1, wherein the circuit board has at least one first location hole penetrating through a front surface and a rear surface of an upper portion of the circuit board, an upper portion of the bracket has at least one second location hole penetrating through a front surface and a rear surface of the bracket, the at least one first location hole is corresponding to the at least one second location hole.

3. The optical sensing module as claimed in claim 2, wherein a quantity of the at least one second location hole is corresponding to a quantity of the at least one first location hole.

4. The optical sensing module as claimed in claim 2, wherein a lower surface of the bracket slantwise extends downward and frontward to form a fastening portion, two sides of the fastening portion defines two third location holes penetrating through a front surface and a rear surface of the fastening portion, respectively, a middle of the fastening portion defines a fourth location hole penetrating through the front surface and the rear surface of the fastening portion, the fourth location hole is disposed between the two third location holes.

5. The optical sensing module as claimed in claim 2, wherein the circuit board has two abreast first location holes penetrating through the front surface and the rear surface of the upper portion of the circuit board, the bracket has two abreast second location holes, the two second location holes penetrate through a front surface and a rear surface of the upper portion of the bracket, the two second location holes are transversely arranged, the two first location holes are corresponding to the two second location holes.

6. The optical sensing module as claimed in claim 1, wherein inner surfaces of the plurality of the blocking walls are recessed outward to form a plurality of buckling grooves penetrating through bottom surfaces of the plurality of the blocking walls, two substantial middles of two sides of the circuit board are buckled in the plurality of the buckling grooves.

7. The optical sensing module as claimed in claim 1, wherein a middle of a rear surface of an upper portion of the bracket extends rearward and then is bent inward to form a second locking hook, the circuit board is fastened to a rear surface of the bracket by the first locking hook and the second locking hook.

8. The optical sensing module as claimed in claim 7, wherein a lower portion of one side of the circuit board is hooked by the first locking hook, an upper end of the circuit board is hooked by the second locking hook.

9. A handheld device casing, comprising:
a rear cover having a first extending portion and a second extending portion, a lower portion of a front surface of the rear cover extending frontward to form the first extending portion, the lower portion of the front surface of the rear cover extending frontward to form the second extending portion;
an optical sensing module disposed in the rear cover, an upper end and a lower end of the optical sensing module being corresponding to a front of the first extending portion and a front of the second extending portion, the optical sensing module including
a bracket, an upper portion of the bracket being mounted to the front of the first extending portion, a lower portion of the bracket being mounted to the front of the second extending portion of the rear cover, the bracket having an isolating wall, the bracket being hollow, the isolating wall being disposed in a middle of an inside of the bracket, the isolating wall being connected with two opposite sides of the bracket, the inside of the bracket being separated into a first opening and a second opening by the isolating wall,
a circuit board disposed in the bracket, an upper portion of the circuit board being corresponding to the front of the first extending portion, the upper portion of the circuit board being mounted to the front of the first extending portion,
a light emitting diode disposed to a front surface of the circuit board, the light emitting diode being located in the first opening,
an infrared sensor disposed to the front surface of the circuit board, the infrared sensor being located in the second opening, the isolating wall being located between the light emitting diode and the infrared sensor, and
a first shading structure disposed to an upper portion and an outer side of the first opening, the first shading structure shielding the upper portion and the outer side of the first opening:
a frame disposed to the front surface of the rear cover; and
a shell disposed to a front surface of the frame, the shell having a lens, a light guiding column and a second shading structure, the lens being corresponding to the infrared sensor, the light guiding column being corresponding to the light emitting diode, the light guiding column being located between the first shading structure and the second shading structure, the second shading structure being disposed to a lower portion and the outer side of the first opening, the second shading structure being adjacent to an inside of the first shading structure, the second shading structure shielding the lower portion and the outer side of the first opening.

10. The handheld device casing as claimed in claim 9, wherein several portions of two inner surfaces of the two opposite sides of the bracket extend inward to form a plurality of blocking walls, the plurality of the blocking walls are disposed at two inner surfaces of two opposite sides of the first opening and an inner surface of one side of the second opening, a rear of one side of the bracket extends rearward and then is bent inward to form a first locking hook, the first locking hook is disposed in the second opening, the circuit board is located among the first locking hook and the plurality of the blocking walls.

11. The handheld device casing as claimed in claim 10, wherein a middle of a rear surface of an upper portion of the bracket extends rearward and then is bent inward to form a second locking hook, the circuit board is fastened to a rear surface of the bracket by the first locking hook and the second locking hook.

12. The handheld device casing as claimed in claim 11, wherein a lower portion of one side edge of the frame is recessed inward to form a notch, the notch is corresponding to the first opening, the second opening, the first shading structure, the shell has a third locking hook, the lens, the light guiding column, the second shading structure and the third locking hook are corresponding to the notch, a rear surface of the shell extends rearward to form the third locking hook, the third locking hook is disposed under the lens, the third locking hook is buckled with the notch of the frame.

13. The handheld device casing as claimed in claim 9, wherein the first extending portion has at least one first locating pillar penetrating through the front of the first extending portion, the circuit board has at least one first location hole penetrating through a front surface and a rear surface of the upper portion of the circuit board, an upper portion of the bracket has at least one second location hole penetrating through a front surface and a rear surface of the bracket, the at least one first location hole is corresponding to the at least one second location hole, the at least one first location hole and the at least one second location hole are corresponding to the at least one first locating pillar.

14. The handheld device casing as claimed in claim 9, wherein the circuit board has two abreast first location holes penetrating through a front surface and a rear surface of the upper portion of the circuit board, the bracket has two abreast second location holes, the two second location holes penetrate through a front surface and a rear surface of an upper portion of the bracket, the two second location holes are transversely arranged, the two first location holes are corresponding to the two second location holes, the first extending portion has two first locating pillars penetrating through the front of the first extending portion, the two first locating pillars are disposed to two opposite sides of the first extending portion, respectively, the two first locating pillars are corresponding to the two first location holes and the two second location holes.

15. The handheld device casing as claimed in claim 14, wherein the second extending portion has two fastening pillars and a second locating pillar, two opposite sides of the second extending portion extending frontward to form the two fastening pillars, two middles of the two fastening pillars penetrate through the front of the second extending portion, the second locating pillar is disposed between the two fastening pillars, a lower surface of the bracket slantwise extends downward and frontward to form a fastening portion, two sides of the fastening portion defines two third location holes penetrating through a front surface and a rear surface of the fastening portion, a middle of the fastening portion defines a fourth location hole penetrating through the front surface and the rear surface of the fastening portion, the fourth location hole is disposed between the two third location holes, the two fastening pillars are corresponding to the two third location holes, respectively, the second locating pillar is corresponding to the fourth location hole.

16. The handheld device casing as claimed in claim 9, wherein the lower portion of the front surface of the rear cover extends frontward to form an abutting portion, the abutting portion is disposed between the first extending portion and the second extending portion, a lower portion of the circuit board is corresponding to the abutting portion of the rear cover, the lower portion of the circuit board is mounted to the abutting portion of the rear cover, the lower portion of the bracket is corresponding to the front of the second extending portion of the rear cover.

17. The handheld device casing as claimed in claim 16, wherein a length of the second extending portion is longer than a length of the abutting portion.

18. The handheld device casing as claimed in claim 9, wherein a length of the first extending portion is longer than a length of the second extending portion, the second extending portion is positioned below the first extending portion.

19. A handheld device casing, comprising:
a rear cover, a lower portion of a front surface of the rear cover extending frontward to form a first extending portion, the lower portion of the front surface of the rear cover extending frontward to form a second extending portion, the lower portion of the front surface of the rear cover extending frontward to form an abutting portion, the abutting portion being disposed between the first extending portion and the second extending portion, a length of the first extending portion being longer than a length of the second extending portion, and the length of the second extending portion being longer than a length of the abutting portion;
an optical sensing module disposed in the rear cover, an upper end and a lower end of the optical sensing module being corresponding to a front of the first extending portion and a front of the second extending portion, the optical sensing module including
a bracket, an upper portion of the bracket being mounted to the front of the first extending portion, a lower portion of the bracket being mounted to the front of the second extending portion of the rear cover, the bracket having an isolating wall, the bracket being hollow, the isolating wall being disposed in an inside of the bracket, the inside of the bracket being separated into a first opening and a second opening by the isolating wall,
a circuit board disposed in the bracket, an upper portion of the circuit board being mounted to the front of the first extending portion, a lower portion of the circuit board abuts against the abutting portion of the rear cover,
a light emitting diode disposed to a front surface of the circuit board, the light emitting diode being located in the first opening,
an infrared sensor disposed to the front surface of the circuit board, the infrared sensor being located in the second opening, the isolating wall being located between the light emitting diode and the infrared sensor, and
a first shading structure disposed to an upper portion and an outer side of the first opening, the first shading structure shielding the upper portion and the outer side of the first opening:
a frame disposed to the front surface of the rear cover; and
a shell disposed to a front surface of the frame, the shell having a lens, a light guiding column and a second shading structure, the lens being corresponding to the infrared sensor, the light guiding column being corresponding to the light emitting diode, the light guiding column being located between the first shading structure and the second shading structure, the second shading structure being disposed to a lower portion and the outer side of the first opening, the second shading structure being adjacent to an inside of the first shading structure, the second shading structure shielding the lower portion and the outer side of the first opening.
